(19) United States
(12) Patent Application Publication
(10) Pub. No.: US 2021/0270350 A1
(43) Pub. Date: Sep. 2, 2021

(54) SELF CLAMPING TRACTION REDUCTION OR SPEED INCREASER DRIVE

(71) Applicant: ULTIMATE TRANSMISSIONS PTY LTD, New South Wales (AU)

(72) Inventor: Michael DURACK, New South Wales (AU)

(73) Assignee: ULTIMATE TRANSMISSIONS PTY LTD, New South Wales (AU)

(21) Appl. No.: 17/260,539

(22) PCT Filed: Jul. 7, 2019
(86) PCT No.: PCT/AU2019/050741

§ 371 Date: Jan. 14, 2021

(30) Foreign Application Priority Data
Jul. 14, 2018 (AU) 2018902551

(51) Int. Cl. F16H 13/08; F16H 13/14

(52) U.S. Cl. CPC F16H 13/08; F16H 13/14

(57) ABSTRACT

An epicyclic traction drive transmission, including a carrier having a central axis, a sun shaft rotationally mounted within the carrier, a plurality of planet rollers mounted on the carrier, and an outer ring. Wedge rollers associated with each planet roller are located in a wedging slot defined between the ring and the planet roller. A resistance mechanism is provided so that the wedge roller's movement into the wedging slot is resisted by a force that is transferred to the carrier.

### TECHNICAL FIELD

The present invention is concerned with epicyclic concentric friction and traction drives.

### BACKGROUND OF THE INVENTION

Friction drives are drives in which hard rollers roll on each other or on hard discs and transfer motion using the frictional coefficient at the surface. Most often these drives take the form of an epicyclic system consisting of a sun, a series of planets and a ring rolling on each other in a lubricant. These friction drives can also operate as traction drives which employ a special lubricant called a traction fluid that has the ability to significantly increase its viscosity when under pressure. It is this form of epicyclically arranged traction drive addressed by this invention using either friction or traction.

There are basically two types of these devices. In one type, the clamping force necessary to cause the fluid or grease to solidify under pressure is created elastically, for example as disclosed in U.S. Pat. No. 6,960,147 B2 (Rotrex). In a second type, the clamping force is created using a form of wedging so that the clamping force is proportional to the torque being transmitted. It is this type to which the present invention is most closely related.

Within this group, two distinct types are also found. One of these uses a form of actuation that cause conical surfaces to ride up on each other in an axial direction and create radially directed forces, for example as disclosed in U.S. Pat. No. 8,608,609 B2 (Van Dyne) and U.S. Pat. No. 6,095,940 (Timken).

However, the present invention is particularly concerned with systems which use wedging rollers that wedge into the slot formed by the rollers and the ring so that the traction forces that develop at the roller and ring contacts force the wedging roller into the wedging slot creating large clamping forces that are proportional to the TAN of half the wedging slot angle shown in FIG. 1 as α.

Within this group are concentric and eccentric variants. The eccentric variants place the sun off centre to the ring, for example as disclosed in U.S. Pat. No. 7,153,230 (Timken) and EP 0877181 A1 (NSK). The concentric arrangement is disclosed, for example, in U.S. Pat. No. 8,123,644 B2 (JP) and U.S. Pat. No. 8,092,332 B2 (Timken). This invention can be applied to both concentric and eccentric self clamping variants.

The present applicant has disclosed an improved epicyclic drive in PCT/AU2019/050057, the disclosure of which is hereby incorporated by reference. FIGS. 1 and 2 are taken from that filing,

In FIGS. 1 and 2 is shown a ring 1 that encircles a carrier 7. The carrier supports axles 5 in slots 8 with rollers 4A, 4B, and 4C running on bearings 6 equally spaced within the carrier. A central sun 9 is located touching the three planets. Wedge rollers 2A, 3A, 2B, 3B, 2C, and 3C are urged into the gap between the ring and the planets in this case using an elastic belt 11A and 11B.

The wedging gap forms an angle created by the tangents at the contacts of the wedge roller with the planets and the ring. This wedging angle is shown as the angle α in FIG. 1. In operation, if torque is applied to the sun it will transfer to an output torque in both the ring and the carrier. As torque increases the wedge rollers are forced into the wedging slots by traction forces that are created at the contacts with the ring and the planet. This causes a normal force to resist these traction forces so that the wedge roller cannot move further into the gap. The size of the normal force is generally proportional to the torque being transferred.

The implementations disclosed by the applicant in in that application (although perfectly adequate under many circumstances) suffers from two issues that compromise the ability to carry the maximum torques that could be sustained by the components as shown in FIGS. 1 and 2, or alternatively reduce the effective life for such a device.

The first problem is that unless the sizes of the wedge rollers and planets are manufactured in a 100% precise manner, and the bearings are manufactured with zero clearance, in operation an imbalance of forces will develop on the three wedge rollers against the ring that must be borne by the bearings supporting the ring, parts 18 and 17 in FIG. 2 and the needle roller bearing 17A that supports one end of the sun shaft 9. The reason for this is that unless the three wedge rollers become stable when under load in precisely the same position as each other along the wedging slot the wedging angle will be different and the clamping force directed to the sun from each of the three planet rollers will be different. As soon as these forces are unequal the combined clearances of the bearings that support the sun and those that support the ring will allow further movement of the wedge rollers along the wedging slot and an even greater difference in the three wedging forces will result leading to even greater loading of the supporting bearings.

The sensitivity of the wedging force expressed in this case as a relative traction coefficient and position within the slot can be seen in the graph shown in FIG. 3. For example, if the wedge rollers are 8.4 mm and 8.6 mm in diameter (or this is the combined effect of a wedge roller and planet diameter difference) the distance the wedge rollers move into the wedging gap varies from 15 mm to 12 mm a resulting difference in position within the wedging gap of around 3 mm. This causes a difference in traction coefficient of 0.08 to 0.065 or around 20% causing very large unbalanced forces. This assumes that the ring diameter is 60 mm the planet 20 mm and the sun 5 mm although many other combinations will show similar results.

The second problem is that when the wedge rollers come under load and are forced into the wedging slots by the traction force, several forms of deflection are initiated that cause the wedge angle to decrease and so create more normal force on the rolling contacts than is required to simply prevent slip. The system becomes over clamped and will so exhibit a loss of life (decreased time before failure) caused by stress repetitions that is greater than if the contacts had only been adequately clamped. These deflections are associated with what is called Hertzian stress approach in which the rotating centre of one roller moves closer to the rotating centre of the other roller.

In this design there are three contact points—sun to planet, planet to wedge roller, wedge roller to ring. The only way to reduce these deflections is to reduce the clamping force or to increase the size of the rollers either in diameter or face width. An additional deflection associated with the global expansion of the ring under ring tension occurs along with deflections associated with the stiffness of the ring relative to its perfect circular shape. An additional deflection is also present, which is associated with the bending of the ring between any stiffening structures capturing it from the side and assisting with the maintenance of its circular shape. The combined effect of these multiple deflections is that the wedge roller moves further and further into the slot causing an ever decreasing wedging angle and corresponding increasing clamping force. In a worst case scenario the wedge roller “pops” through the gap between the planet and the ring. It is of particular importance to understand that vehicle transmissions are often subject to short lived, but severe torque overloads that with gears can break gear teeth. With this type of transmissions torque spikes could cause a roller to pop through the gap even when the torque spike is short lived. It is also important to note that if the vehicle to which the transmission is being used is an electric vehicle, it is unlikely that any other form of clutch, often present in an Internal Combustion Engine (ICE) powered vehicle, is in place with the ability to act as a torque fuse.

It an object of the present invention to alleviate either, or both of, the imbalance of forces problem and the over-clamping problem.

### SUMMARY OF THE INVENTION

In a first broad form, the present invention provides a resistance mechanism which provides a force opposing over-clamping of the wedging rollers.

According to one aspect, the present invention provides an epicyclic traction drive transmission, including a carrier having a central axis, a sun shaft rotationally mounted within the carrier, a plurality of planet rollers mounted on the carrier and arranged to rotate on respective angularly equidistant axles, and rotationally engage the sun shaft; an outer ring, rotationally mounted on an axis within the carrier; and at least one wedge roller associated with each planet roller and locating in a wedging slot defined between the ring and the planet roller, the wedge roller being free to translate relative to the carrier around the central axis; wherein in use tangential traction forces develop between each wedge roller and the ring and the planet directed into the wedging slot; normal forces develop between the wedge roller the ring and the planet which cause an outward deflection of the ring and inward deflections of the wedge roller, planet and sun; and wherein a resistance mechanism is provided so that the wedge roller's movement into the wedging slot is resisted by a force that is transferred to the carrier.

Implementations of the present invention accordingly provide a mechanism which acts to oppose the wedge rollers moving excessively into the wedging gap, and so provides an improved drive mechanism.

### BRIEF DESCRIPTION OF THE DRAWINGS

Illustrative implementations of the present invention will now be described with reference to the accompanying figures, in which:

FIG. 1 is a schematic plan view of a drive according to PCT/AU2019/050057;

FIG. 2 is a cross-sectional view of the drive of FIG. 1;

FIG. 3 is graph showing variations in traction co-efficient and position of the wedge roller with wedge roller radius;

FIG. 4 is a graph showing the relationship between applied torque and wedge position when the movement is not constrained;

FIG. 5 is a graph of normal force and wedge movement when the movement is abruptly constrained;

FIG. 6 is a graph of normal force and wedge movement, when the movement is progressively constrained;

FIG. 7 is cross-sectional view of a first implementation of the present invention, along line C of FIG. 8, and FIG. 7A is an enlarged view of part of FIG. 7;

FIG. 8 is a plan view of the first implementation;

FIG. 9 is a plan view, with the casing partly removed looking at it in the direction A of FIG. 7;

FIG. 10 is a cross section view of a device according to an embodiment of the invention;

FIG. 11 shows a plan view with the casing partly removed of a second embodiment; and

FIG. 12 shows a plan view of a third embodiment.

### DETAILED DESCRIPTION OF THE INVENTION

The implementations described below are intended to illustrate possible implementations of the present invention, and not to be limitative of the scope of the invention. The present invention is applicable to various designs of traction and friction drives, including concentric and eccentric designs, and the detailed description should be read in that light.

As described in the background discussion, one issue with the prior design is that unbalanced forces result from small imperfections in tolerances. One strategy that could be used is careful examination of the manufactured parts so that matching sets can be assembled that reduce the absolute difference in sizes between the wedge rollers and planet pairing. However at least some of the unmatched forces will remain.

A more effective way of eliminating unbalanced forces is to capture each wedge roller in a structure that ensures that the angle that exists between each wedge roller in each group that carries the negative or positive torque is always equal. Although the accuracy of such a structure will still be dependent on machining or manufacturing accuracy, a small relative movement into the wedging slot will cause only a very small difference in clamping force. In this way, each of the wedge rollers can only enter the wedging slot an equal amount causing the (in this case) three clamping forces to remain equal. Ideally, the three rollers that transfer positive torque are captured by one structure and the rollers that capture negative torque are held in another independent structure. In this way, an elastic component can pull these structures together and so provide the preload required to initiate clamping as depicted in the PCT already cited as either a spring ring or an elastic belt. Alternatively, a single structure supports all six rollers as shown in the earlier PCT

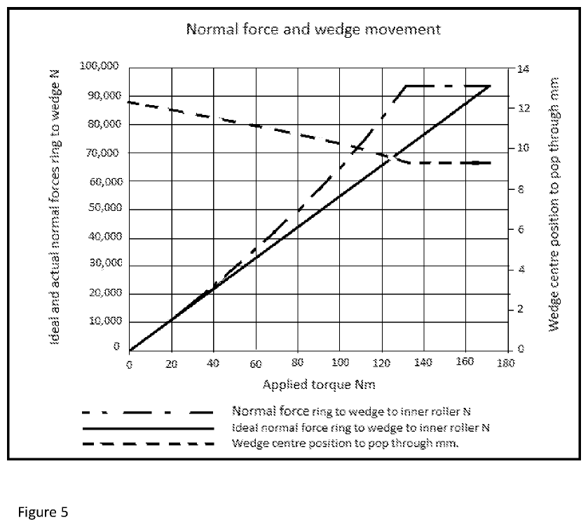

The wedge rollers can be captured in such a way that the progressive buildup of clamping force is allowed to occur freely, until it reaches a maximum, at which point the withholding structure stops any further movement and the clamping force cannot increase. FIG. 4 shows graphically how this clamping force builds up exceeding the value determined to be ideal, in a somewhat exponential manner. In this case the wedge roller moves almost 6mm further into the slot than ideal because of the deflections associated with both the ring stiffness and Hertzian contact approaches.

If the movement into the slot of the roller is arrested abruptly by the supporting structure at a point where it reaches the maximum ever required for the particular design, the graph of forces and movement takes on that shown in FIG. 5, wherein when the clamping reaches a force of around 93,000 N it does no longer increase with that amount of force being adequate to carry the intended maximum input design torque of 110 Nm. In this case, it is assumed that the Ring is 114.4 mm, the planet 41.6 mm, the sun 10.4 mm, and the wedge roller 11.16, in diameter and 50 mm long with an initial operating traction coefficient of 0.08.

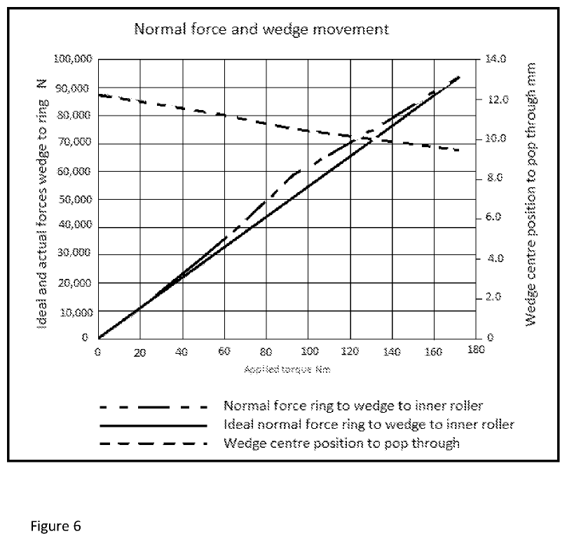

If, instead of abruptly arresting the possible increase of clamping force, an elastic member is caused to oppose the movement progressively at some point during the development of the clamping force, FIG. 6 illustrates what is achieved. In this case, a constant rate spring was used of 1,550 N/mm and introduced 30% into the clamping curve development. The small kink in the dot dash line represents the point the retaining structure meets the resistance of the spring. The ideal clamping force is exceeded slightly at one third of the way but is back to ideal at the end.

If a variable rate spring was used to provide the resistance it would be possible to match the ideal clamping force and the actual clamping forces even better.

It can be seen that it would be possible to apply any one of these strategies to either the rollers acting in the positive direction or the rollers acting in the negative direction. It can also readily be seen that all three strategies could be applied simultaneously to obtain the most ideal result for particular circumstances.

Because the wedge rollers must continually rotate, in a preferred embodiment, low-friction bearings may be provided within the supporting structure that act to provide the resisting forces. This can be done in at least two ways. The wedge rollers may be provided with small axles extending out of either end, which then may be supported by low-friction bearings located in the support structure. Alternatively-the wedge rollers may be made hollow, with axles passing through them, which roll on bearings located at either end within the support structure. It is also possible to arrest the rollers independently using independent structures for each roller or pair of rollers. In some mechanisms that use an offset sun and only one wedging roller, a similar strategy could be used to overcome this problem of deflection induced over clamping.

It is also possible to use the same force arresting structures to apply the preload required to initiate traction force induced clamping. This can be done using an actuator that applies a force on demand, or an elastic component that applies a continuous rotating force onto each structure independent of the other. It can also be provided by reacting the structure that supports the rollers transferring positive torque onto the structure that supports the rollers transferring negative torque. It is understood that by applying a relatively large preload force, the initial wedging angle can initially be larger using both the traction force and the preload force to initiate wedging. In this way the forces needed to reduce the clamping force later, when it exceeds what is required, can be reduced, reducing the load carried by the structure and the loads on the bearings that support the wedge rollers.

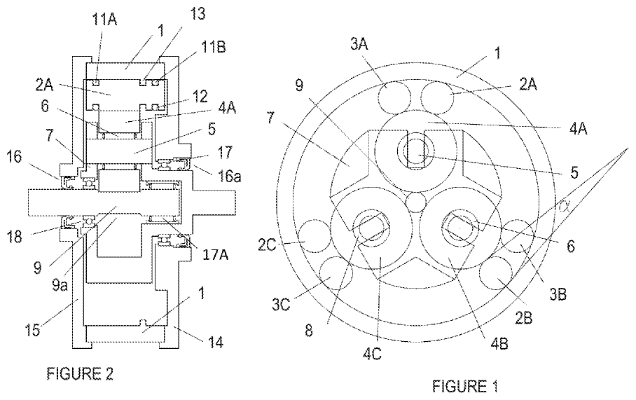

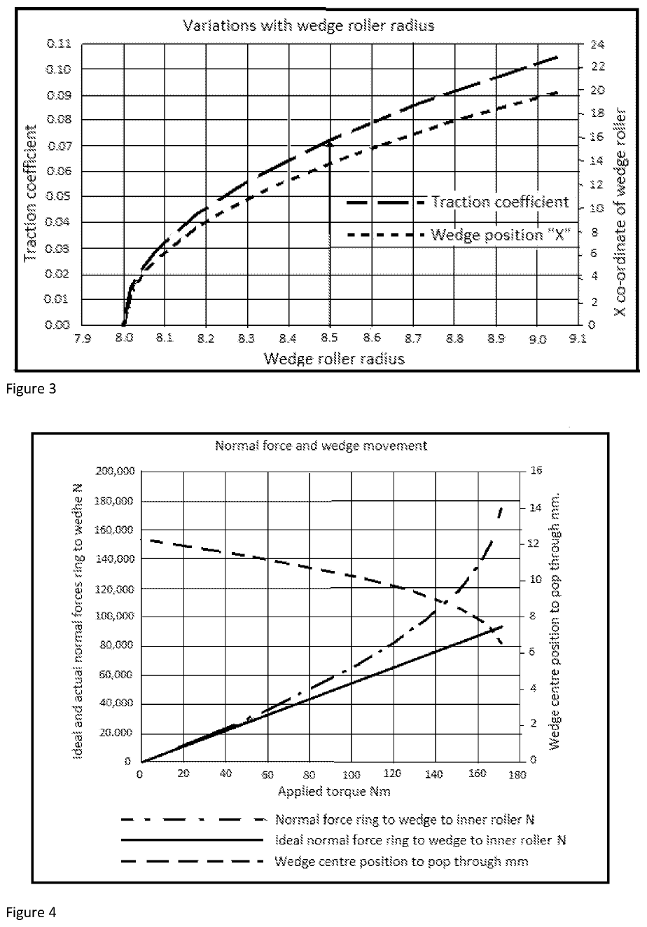

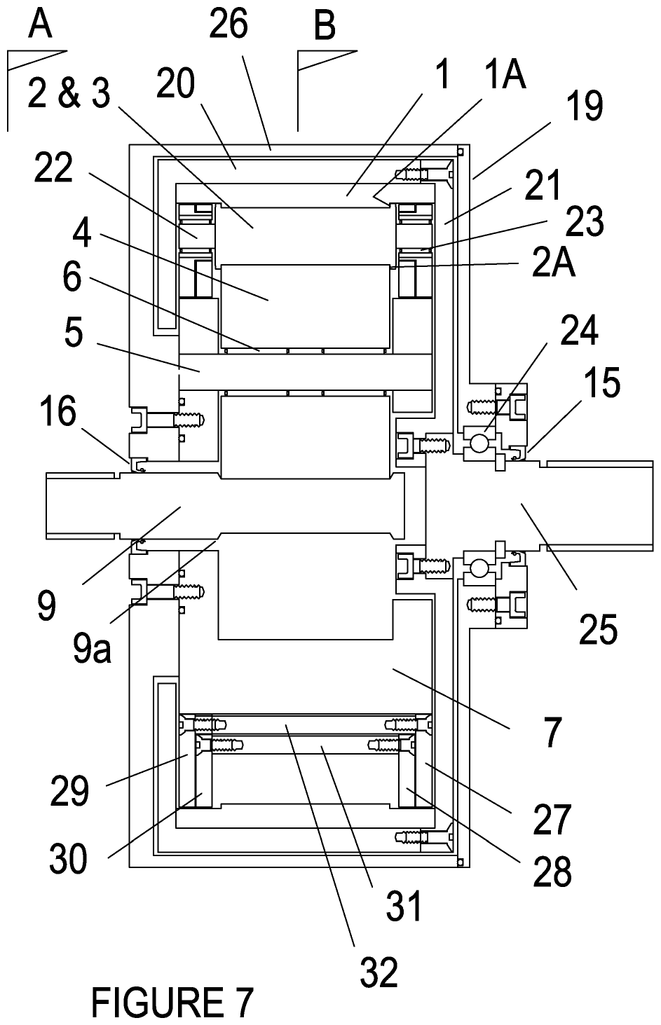

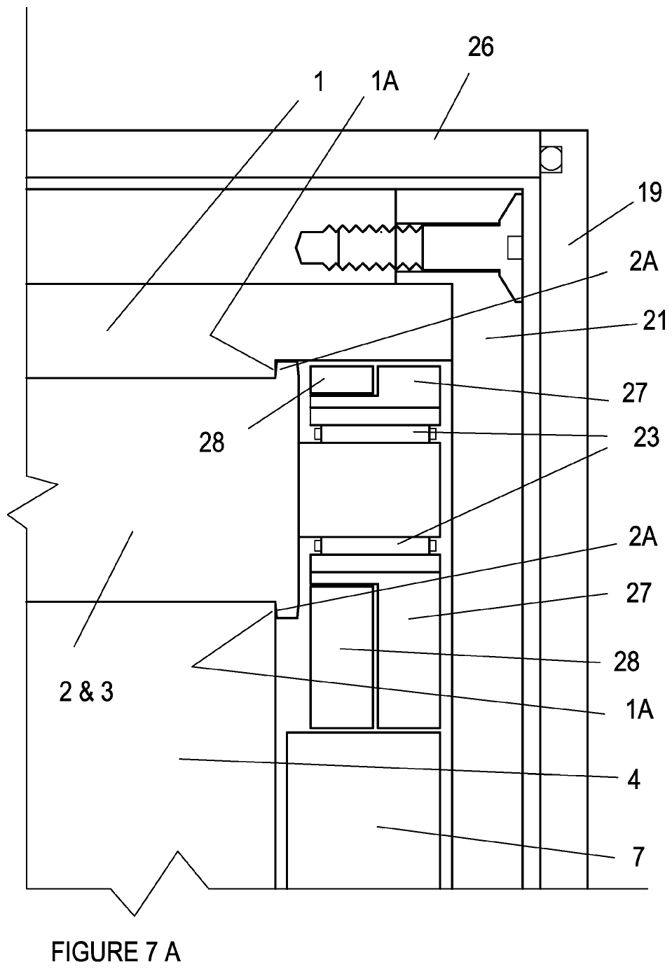

A first embodiment of this invention is shown in FIGS. 7, 8, 9, and 10. The components already present in FIG. 1 and FIG. 2 are present here, however ring 1 is formed with a step 1 a at either end that engages with lands 2A formed in the wedge rollers (2 & 3) so as to retain the wedge roller in the axial direction. A similar step 9a is formed in sun 9. The planets 4 are each now retained axially by the lands 2A in the wedge rollers 2, 3 and in turn retain the sun 9 axially engaging with the step 9A formed in it. In this embodiment there is no elastic member pulling the rollers together and so no grooves in the rollers.

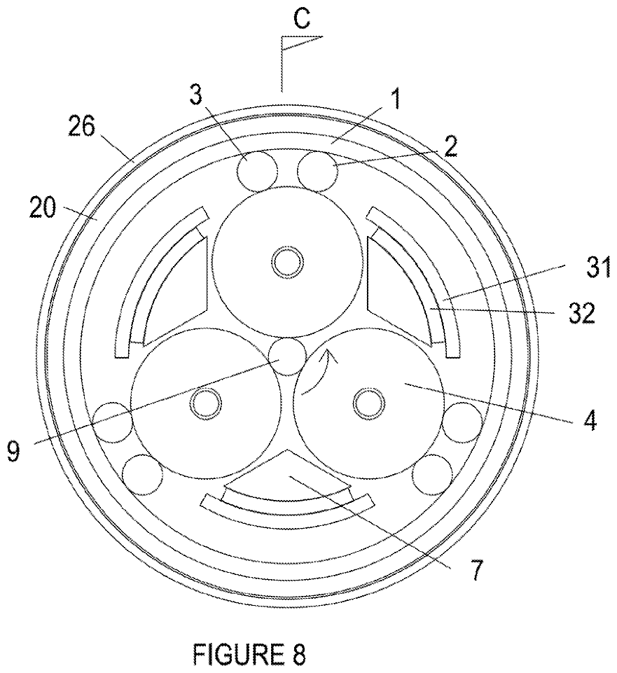

FIG. 7 is a section through a device shown in FIG. 8 along the plane indicated by C that includes two three-part assemblies supporting the wedging rollers 2 and 3 that can apply a preload force to the wedge rollers. The first assembly is formed of parts 27, 32 and 29 that support three of the wedge rollers, the second assembly is formed of parts 28, 31 and 30 that support the other three wedge rollers. Both assemblies support the six wedge rollers in bearings 23 on small axles 22 formed as part of the wedge rollers 2 & 3.

Within this casing the other parts found in these devices are also located, including a sun 9, ring 1 and planets 4 running on axles 5 on bearings 6 located in slots in a stationary carrier case 7.

Additional parts 20 and 21 retain the ring 1 with 21 connected to an output shaft 25 that runs in a bearing 24 supported on the casing. The two assemblies that hold the wedge rollers can rotate freely around the central axis or the rotational centre of the sun and the output shaft.

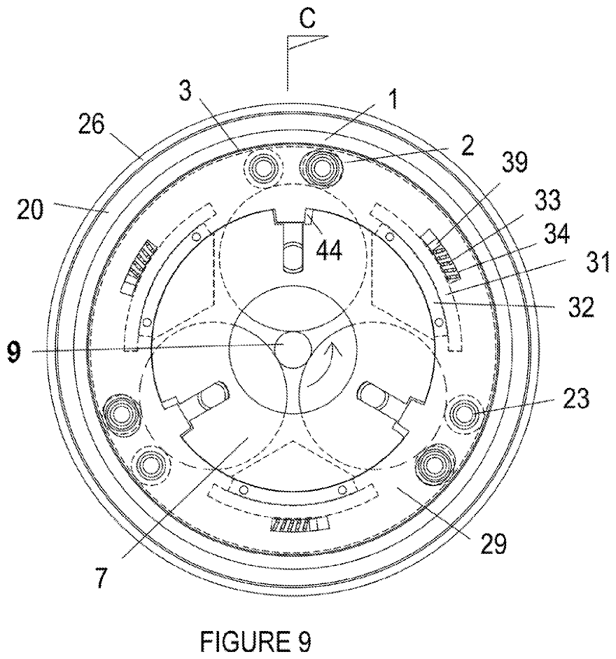

FIG. 9 shows a view of the assembly with the casing partly removed, looking at it in the direction A shown in FIG. 7. The part 29, which forms part of the structure holding three of the rollers, is clearly visible.

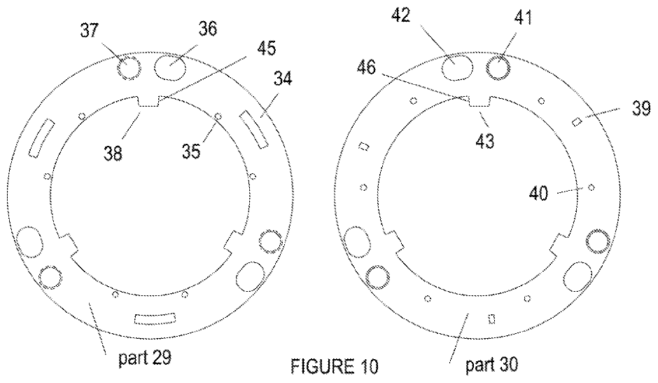

FIG. 10 shows the two parts 29 and 30 that lie immediately under each other and support one side of each set of three rollers, forming parts of the first and second assemblies. Parts 29 and 30 are connected to respective supporting parts 31 and 32 by bolting through holes 35 and 40.

It can be seen from FIGS. 9 and 10 that the parts 29 and 30 are arranged to be displaced relatively to each other as are parts 27 and 28 by reacting a lug 39 formed on the face of part 30, against one side of a slot 34 cut in part 29 using a suitable compression spring 33. The bearings 23 supporting the wedge rollers 2, 3 are held by parts 29 and 30 and the matching parts 27 and 28 in apertures 37 and 41 which pass through elongated slots 42 and 36 which allow the parts to rotate around the central axis relative to each other sufficiently for the full wedging movements of the wedging rollers to occur. The spring 33 provides the preload that reduces as the wedge rollers become forced into the wedging slots and the spring expands. A similar tension spring could create the same action.

The inwardly facing keys 38 and 43 protruding out of parts 29 and 30 engage with slots in the carrier 44 which allow some rotational movement until faces 45 and/or 46 in keys 38, 43 are restrained by matching faces in the slots 44. In this way the wedging action is restrained to achieve the clamping forces expressed in FIG. 5.

By incorporating springs in the slots and keys, the clamping forces can be arranged to match that shown in FIG. 5. It will be appreciated that these reacting forces can also be arranged to act directly off the body of the carrier case or the carrier 7 of the planets 4.

In such a way the present invention can be applied to other forms of self-wedging drives, including the designs that use an off centre sun and a single wedge roller. The spring 33 could function as both a compression and tension member creating preload and then resistance as the clamping force exceeds what is needed, provided the assemblies themselves are restrained from rotating too far in the opposite direction by lugs and grooves similar in function to 38, 43, & 44.

In this embodiment, because the three rollers in each group are forced to remain in fixed angular position to each other and because the two groups are preloaded onto the planets, the structures into which they are fitted remain constrained to rotate around the centre of rotation of the sun shaft and output shaft without needing any other support. It can also be seen that the sun need not be supported on any bearings as the planets locate them in all directions. The retaining assemblies of the rollers must have sufficient radial flexibility to accommodate the small outward deflection of the ring but do not require any circumferential flexibility.

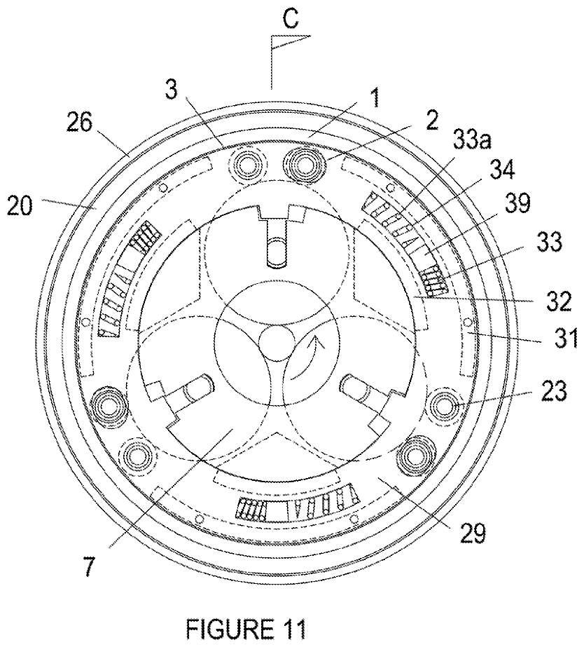

In a second embodiment shown in FIG. 11, the first and second assemblies that support wedge rollers 2, 3 can be reacted off each other as in the embodiment described in FIGS. 7, 8, 9, and 10 using a compression spring 33 which provides a preload force. After the wedge rollers begin to enter the wedging slot, the spring 33 will expand and cease to provide preload while a similar spring 33a will begin to stop any further movement of the wedging roller into the slot creating the force trajectory expressed in FIG. 6.

In order for the independent first and second supporting assemblies to be able to carry the force from spring 33a they engage with the slots 44 in the carrier 7 in such a way that the wedge roller 2, 3 cannot rotate out of the slot in the opposite direction to that required for clamping further than the extent required to just unload wedge rollers 2, 3. It can also be seen that the spring 33a could also be a stop once fully collapsed creating the force trajectory expressed in FIG. 5, or combining elements of both the FIG. 5 and FIG. 6 scenario.

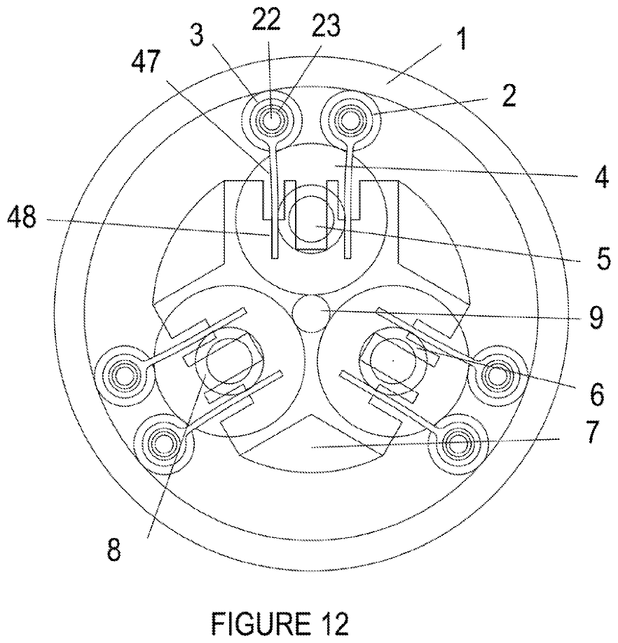

In another embodiment shown in FIG. 12, the wedge rollers 2, 3 are held by parts 47 which include a ring that wraps around the casing of bearing 23 which in turn runs on the roller axle 22 that extends out of both ends of the roller 3. Part 47 has a flexible leg that is inserted into slots or holes 48 in the carrier 7. The parts 47 are designed to apply a preload against all of the rollers independently, when no torque is being applied to the sun 9. When torque is applied, either set of rollers 2 or rollers 3 (depending upon the direction of rotation) are forced into the wedging slot and the preload reduces. At predetermined point the parts 47 come under a reversed load and their elastic stiffness begins to resist any further movement of the roller into the slot creating the force trajectory shown in FIG. 6. With this embodiment, because the wedging rollers are not connected by an encircling ring, it is necessary for the sun 9 to be supported on its own bearings with these bearings carrying the unbalanced forces created by manufacturing tolerances and bearing clearances.

The first and second assemblies, in their various implementations, can be seen to act to resist the clamping forces, and so to act as a resistance mechanism to act against excessive clamping forces. It will be appreciated that alternative resistance mechanisms to the specific examples described may be used to provide the required opposing forces to prevent excessive clamping.

It can readily be seen that many other possible alternative designs can be devised by those skilled in the art, using this invention to provide a combination of preloading force and restraining force so as to better manage the clamping forces and associated deflections that develop in drives that rely on clamping forces developed by wedging rollers,

It can also readily be seen that the design is not limited to mechanisms containing only three planets as any number can in fact be used. The mechanism can also be made to work as a one way mechanism if only one set of wedge rollers is employed to accept torque in only one direction. The mechanism can also be designed with an offset sun as shown in EP 0877181 A1 requiring only one wedging roller using both preload and deflection restraint or just deflection restraint.

While is preferred that the present invention is implemented in association with the invention described in the applicant's earlier application (incorporated herein by reference), in which the frictional or traction coefficient is μ, and the wedge roller defines a wedging angle α, such that tan α/2 is less than μ, the present invention may be implemented in drives which do not conform to this limitation.

1. An epicyclic traction drive transmission comprising: including
a carrier including a central axis, a sun shaft rotationally mounted within the carrier, a plurality of planet rollers mounted on the carrier and arranged to rotate on respective angularly equidistant axles, and rotationally engage the sun shaft;
an outer ring, rotationally mounted on an axis within the carrier; and
at least one wedge roller associated with each planet roller and located in a wedging slot defined between the outer ring and the planet roller, the at least one wedge roller being free to translate movement relative to the carrier around about the central axis;
wherein in use, tangential traction forces develop between each of the at least one wedge roller, and-the outer ring, and the planet roller, the tangential traction forces being directed into the wedging slot;
wherein in use, normal forces develop between each of the at least one the wedge roller, the outer ring, and the planet roller, thereby causing an outward deflection of the outer ring, and inward deflections of the wedge roller, the planet roller and the sun shaft;
and wherein a resistance mechanism is provided so that the movement of the at least one wedge roller into the wedging slot is resisted by a force that is transferred to the carrier.

2. The epicyclic traction drive transmission according to claim 1, wherein the outer ring and the sun shaft are mounted in bearings so that they rotate about the central axis.

3. The epicyclic traction drive transmission according to claim 1, in which wherein the resistance mechanism acts as a stop after a predetermined amount of movement into the wedging slot, and wherein the stop prohibits the at least one wedge roller from passing between the outer ring and the planet roller.

4. The epicyclic traction drive transmission according to claim 1, in which wherein the resistance mechanism applies a force that increases progressively in magnitude as the at least one wedge roller moves further into the wedging gap.

5. The epicyclic traction drive transmission according to claim 1, wherein the at least one wedge roller is mounted in bearings that freely rotate, and wherein the force from the resistance mechanism is directed to the non-rotating part of the bearings by the carrier.

6. The epicyclic traction drive transmission according to claim 1, wherein each of said plurality of planet rollers comprises two wedge rollers, the two wedge rollers being mounted in bearings, the bearings being structurally supported in a structure such that the two wedge rollers of each planet roller remain equally spaced with respect to the other around the central axis.

7. The epicyclic traction drive transmission according to claim 6, wherein the outer ring is mounted in bearings that allow the outer ring to rotate about the central axis, wherein while the sun shaft is simultaneously free to rotate on about a separate axis located an equidistance from an inner surface of each planet roller.

8. The epicyclic traction drive transmission according to claim 6, in which wherein the sun shaft is mounted in bearings that allow the sun shaft to rotate on about the central axis, wherein while the outer ring is simultaneously free to rotate on about a separate axis located an equidistance from an outer surface of each planet roller.

9. The epicyclic traction drive transmission according to claim 1, wherein the resistance mechanism is adapted to provide a pre-load force to ensure initial engagement of the at least one wedge roller in the wedging slot, and then after reaching a predetermined position acts to impede the movement of the at least one wedge roller into the wedging slot.

10. The epicyclic traction drive transmission according to claim 9, wherein the pre-load force is provided by a flexible leg such that after the predetermined position is reached, the resistance mechanism acts elastically to impede further movement of the at least one wedge roller into the wedging slot.
